(19) United States
(12) Patent Application Publication
(10) Pub. No.: US 2008/0049003 A1
(43) Pub. Date: Feb. 28, 2008

(54) Display device

(75) Inventor: Kazuhiro Hasegawa, Kanagawa (JP)

Correspondence Address: BIRCH STEWART KOLASCH & BIRCH, PO BOX 747, FALLS CHURCH, VA, 22040-0747, US

(73) Assignee: FUJIFILM Corporation

(21) Appl. No.: 11/889,401

(22) Filed: Aug. 13, 2007

(30) Foreign Application Priority Data
Aug. 24, 2006 (JP) 2006-228025

(51) Int. Cl. G06F 3/038

(52) U.S. Cl. 345/206

(57) ABSTRACT

A display device including a display unit and a circuit unit for driving the display unit, in which the display unit includes a flexible substrate and can be housed by rolling and drawn out in a predetermined direction, one electrode is a metal electrode, and the other electrode is a stripe-shaped electrode comprising a metal oxide, and a long side of the stripe is disposed perpendicular to a rolling direction of the display device.

### CROSS-REFERENCE TO RELATED APPLICATION

This application claims priority under 35 USC 119 from Japanese Patent Application No. 2006-228025, the disclosure of which is incorporated by reference herein.

### BACKGROUND OF THE INVENTION

1. Field of the Invention

The present invention relates to a display device in which a display unit can be housed by rolling and drawn out.

2. Description of the Related Art

Conventionary, cathode ray tubes were widely used in display devices of data processors, televisions or like. Thereafter, plasma display elements, liquid crystal display elements, and electroluminescence elements (hereinafter, referred to as an EL element), for example, have been used as flat panel display devices for the purpose of saving space. However, since the display devices were formed on nonflexible substrates such as a glass or the like, it was difficult to move or carry the display devices by decreasing thereof. Further, the display elements using a glass substrate are easily damaged due to an impact caused by dropping thereof or the like, whereby it was necessary to handle them with care. Moreover, the weight of the device tends to be increased with an increase in size of a screen of the display device.

In recent years, some flexible display devices for easy mobility and carriage by housing the display elements have been proposed. For example, Japanese Patent Application Laid-Open No. 2002-15858 discloses a display device in which the display element can be rolled in a roll screen shape. Further, Japanese Patent Application Laid-Open No. 2002-328625 discloses a display device in which the display element can be housed by rolling in a cylindrical housing unit. These display devices have a structure in which the EL element formed on a flexible substrate such as plastic can be housed by rolling.

### SUMMARY OF THE INVENTION

The present invention has been made in view of the above circumstances and provides a display device comprising a display unit and a circuit unit for driving the display unit, in which the display unit includes a flexible substrate, a pair of electrodes disposed on the flexible substrate, and at least one display element between the electrodes, wherein the display unit can be housed by rolling and drawn out in a predetermined direction, one electrode is a metal electrode, the other electrode is a stripe-shaped electrode comprising a metal oxide, and a long side of the stripe is disposed perpendicular to a rolling direction of the display device.

### BRIEF DESCRIPTION OF THE DRAWINGS

FIG. 1 is a schematic perspective view of an example of an organic EL display device according to an embodiment of the invention and illustrates an operating state thereof.

FIG. 2 is a schematic perspective view illustrating a state in which the organic EL display device shown in FIG. 1 is housed by rolling.

FIG. 3 is a perspective view of a principal part illustrating a configuration of a display unit and a circuit unit of an organic EL display device to which the present invention has been applied.

FIG. 4 is a plane view of a principal part illustrating a display unit and a circuit unit of an organic EL display device to which the present invention has been applied.

FIG. 5 is a perspective view of a principal part illustrating a configuration of an organic EL element provided in an organic EL display device to which the present invention has been applied.

FIG. 6 is a sectional view of a principal part illustrating a configuration of an organic EL element provided in an organic EL display device to which the present invention has been applied.

FIG. 7 is a schematic perspective view of an organic EL display device to which the present invention has been applied, in which a handle is disposed at one end portion of a display unit, and illustrates an operating state thereof.

FIG. 8 is a perspective view illustrating a state in which a magnet is disposed as means for maintaining a state in which an organic EL display device to which the present invention has been applied, is housed by rolling.

FIG. 9 is a schematic perspective view of an organic EL display device to which the present invention has been applied, in which a rolling unit is disposed at both ends of a display unit and illustrates an operating state thereof.

FIG. 10 is a schematic perspective view illustrating a rolling housing state of the organic EL display device shown in FIG. 9.

FIG. 11 is a schematic perspective view illustrating an operating state of an organic EL display device to which the present invention has been applied, having an opening portion having a circular arc shape for maintaining a concave surface of a display unit.

FIG. 12 is a perspective view of a principal part illustrating a configuration example of an organic EL element.

FIG. 13 is a sectional view of a principal part illustrating a configuration example of an organic EL element.

FIG. 14 is a sectional view of a principal part illustrating a configuration of an inorganic EL element.

FIG. 15 is a sectional view of a principal part illustrating a configuration of a microcapsule-type electrophoresis element.

FIG. 16 is a longitudinal sectional view illustrating a manufacturing process of an organic EL display device to which the present invention has been applied.

FIG. 17 is a longitudinal sectional view illustrating a manufacturing process of an organic EL display device to which the present invention has been applied.

FIG. 18 is a longitudinal sectional view illustrating a manufacturing process of an organic EL display device to which the present invention has been applied.

FIG. 19 is a longitudinal sectional view illustrating a manufacturing process of an organic EL display device to which the present invention has been applied.

FIG. 20 is a plane view illustrating a manufacturing process of an organic EL display device to which the present invention has been applied.

### DETAILED DESCRIPTION OF THE INVENTION

It has been found that a new problem occurs, which did not occur in a display element on a glass substrate, in that a display element using a flexible substrate is damaged due to a bending stress applied by housing by rolling and drawing out. In particular, there are problems in that a stripe electrode extending in a rolling direction of the display element is easily damaged due to a large bending stress and the display element becomes unable to display an image due to repetition of housing by rolling and drawing out.

An object of the present invention is to provide a display device in which a display device is not damaged even when repetition of housing by rolling and drawing out is performed. Further, the object of the invention is to thereby easily provide a display device in which an increase in size of a screen is compatible with a decrease in size and a decrease in weight of the display device, and to provide a display device resistant to an impact such as a drop.

The above-mentioned object of the invention is achieved by the following means.

<1> A display device comprising a display unit and a circuit unit for driving the display unit, in which the display unit includes a flexible substrate, a pair of electrodes disposed on the flexible substrate, and at least one display element between the electrodes, wherein the display unit can be housed by rolling and drawn out in a predetermined direction, one electrode is a metal electrode, the other electrode is a stripe-shaped electrode comprising a metal oxide, and a long side of the stripe is disposed perpendicular to a rolling direction of the display device.

### <2> The display device according to above item <1>, further comprising a housing unit for housing the display unit and the circuit unit.

<3> The display device according to above item <2>, wherein the housing unit comprises an opening portion for moving the display unit into and out of the housing unit, and the opening portion has a circular arc shape so as to hold a curve of the display unit.

### <4> The display device according to above item <2>, wherein the housing unit further comprises a rolling unit for rolling the display unit.

### <5> The display device according to above item <4>, wherein the circuit unit is disposed within the rolling unit.

### <6> The display device according to above item <1>, wherein the display element emits light or changes an optical property by an applied electric field.

### <7> The display device according to above item <1>, wherein the display element is a light emitting element.

### <8> The display device according to above item <7>, wherein the light emitting element is an organic EL element.

According to an aspect of the invention, a display device in which a display element can be housed by rolling and drawn out in a predetermined direction includes a display unit and a circuit unit for driving the display unit, wherein the display unit has a flexible substrate, a pair of electrodes disposed on the flexible substrate, and a display element in which a display component of at least one layer is interposed between the electrodes, and wherein one electrode is a metal electrode (hereinafter, sometimes referred to as a first electrode), the other electrode is a stripe-shaped electrode comprising a metal oxide (hereinafter, sometimes referred to as a second electrode), and a long side of the stripe is disposed perpendicular to a rolling direction of the display device. By this configuration, when the second electrode made of a material having a low bending strength is housed by rolling and drawn out, the bending stress is scarcely applied to the second electrode, which is therefore not damaged. Accordingly, it becomes possible to perform stable display over a long period of time.

Here, an angle between the rolling direction and the long side of the stripe-shaped electrode does not need to be strictly 90°, and it is possible to obtain the same effect even if it inclined somewhat from 90°. Further, the pixels may be arranged in a delta-arrangement by arbitrarily inclining the electrode. Accordingly, a perpendicular direction according to the embodiment of the invention represents a range of 90°±30°.

In the display device of the present invention, breakage of the electrodes of the display element caused by repeated housing by rolling and drawing out is prevented, whereby it becomes possible to perform stable display of an image over a long period of time. It is possible to use the display device in which the display unit can be housed by rolling and drawn out suitably for display on a large screen and to improve saving of space of a storage area by housing the display element. A decrease in weight of the display device can be obtained by using the flexible substrate, whereby it is possible to improve portability of the display and to prevent the display element from being damaged by an impact such as a drop.

Hereinafter, embodiments suitable for the present invention will be described with reference to the accompanying drawings. Here, a display device having an organic EL element serving as a display element is exemplified.

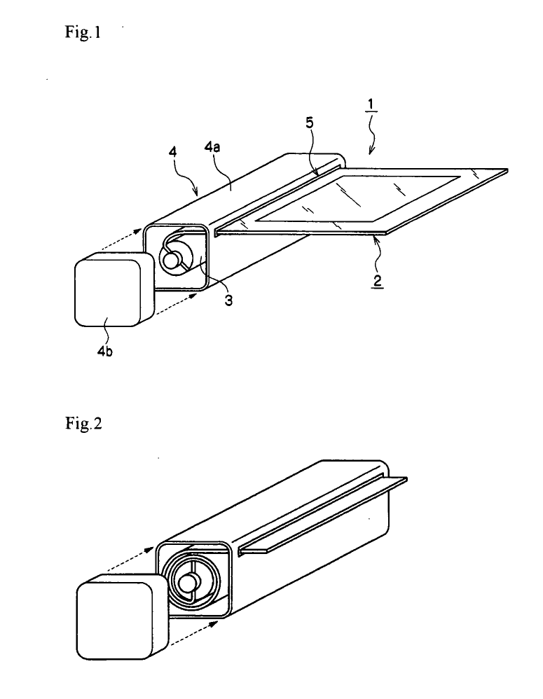

FIG. 1 is a schematic perspective view illustrating a configuration of an organic EL display device to which the present invention has been applied and illustrates an operating state in which a display unit is drawn out. FIG. 2 illustrates a state in which the display unit of the organic EL display device shown in FIG. 1 is housed. The organic EL display device 1 includes a display unit 2, a circuit unit 3 housing a drive circuit disposed at one end portion of the display unit 2, which drives the display unit 2, a power supply circuit supplying power to the entire organic EL display device 1, and a signal processing circuit receiving a display signal, and a housing unit 4 disposed around the circuit unit 3, which houses the display unit 2. Here, the circuit unit 3 has a cylindrical shape and serves as a rolling unit rolling the display unit 2. The housing unit 4 includes a housing unit body 4a and a housing unit cap 4b. After the display unit 2 and the circuit unit 3 are housed in the housing unit body 4a, the housing unit cap 4b is closed, whereby the housing unit 4 is sealed.

The state shown in FIG. 1 represents an operating state of the organic EL display device 1, which allows the display unit 2 to display information. When the organic EL display device 1 is not used or is carried, the organic EL display device 1 is housed by rolling as shown in FIG. 2. When the organic EL display device 1 is used thereafter, the display unit 2 is drawn out again as shown in FIG. 1. The organic EL display device 1 repeats the operating state of FIG. 1 and a non-operating housing state of FIG. 2.

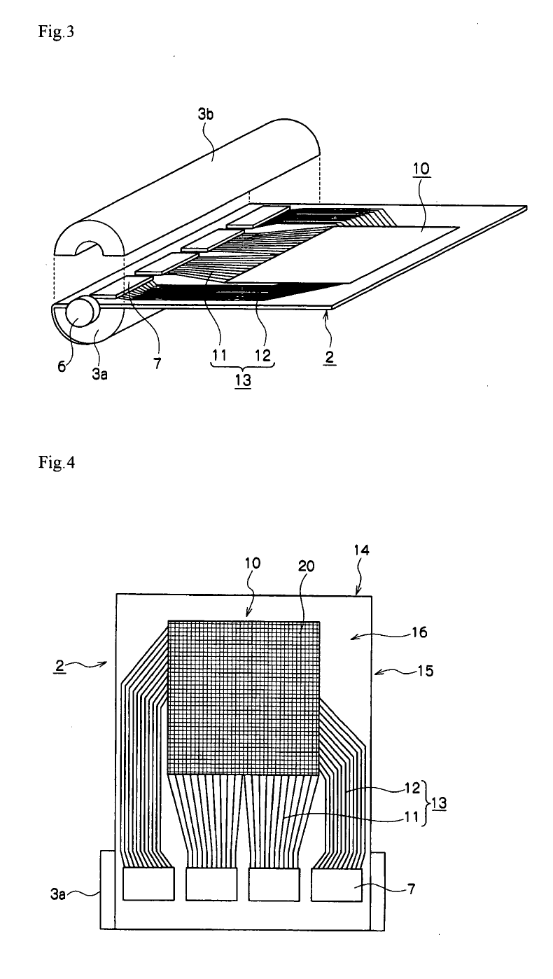

FIG. 3 is a perspective view of a principal part illustrating configurations of the display unit 2 and the circuit unit 3. The circuit unit 3 is partitioned into a circuit housing unit body 3a and a circuit housing unit cap 3b. Drive circuits 7 disposed at one end portion of the display unit 2, a power supply circuit (not shown), and a signal processing circuit (not shown) are housed in the circuit housing unit body 3a. The circuit unit 3 is sealed by placing the circuit housing unit cap 3b. A rotation shaft 6 is provided at a rotational center of the circuit unit 3 and is rotatably engaged with a bearing part (not shown) of the housing unit 4. Here, a rotary connector for inputting and outputting a signal or power from a circuit housed in the circuit unit 3 may be provided adjacent to the rotation shaft 6. By this configuration, since it becomes possible to draw out the power supply circuit or the like from the circuit unit 3, the volume of the circuit unit 3 can be decreased, thereby improving flexibility in design. In addition, it is preferable to charge the circuit unit 3 from the outside. A spiral spring or a clutch may be provided between the rotation shaft 6 and the housing unit 4. By this configuration, it becomes possible to automatically house the drawn out display unit 2 in the housing unit 4 or to draw out the display unit 2 as needed, which is preferable.

FIG. 4 is a plane view illustrating an electrical connection state of the display unit 2 and the circuit unit 3. The display unit 2 includes a pixel unit 10 in which a plurality of organic EL elements is formed on a transparent film-shaped plastic substrate, and a wiring unit 16 in which wirings 13 constituted by longitudinal wirings 11 and transverse wirings 12 are disposed, which electrically connects each of organic EL elements 20 and each of the drive circuits 7 for driving each of the organic EL elements 20. Here, for ease of description, a side facing the circuit unit 3 is called a first side 14 and a side orthogonal to the first side 14 is called a second side 15.

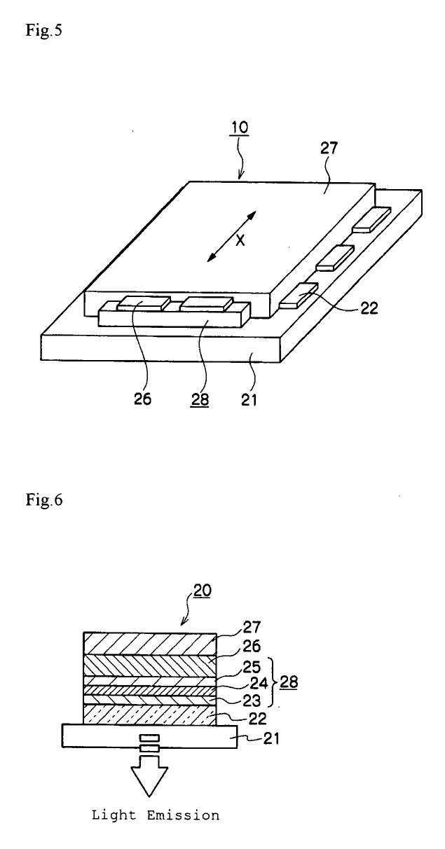

The pixel unit 10 is formed of the plurality of organic EL elements 20 arranged in a matrix. FIG. 5 is a perspective view of a principal part illustrating a configuration of the organic EL element, and FIG. 6 is a longitudinal sectional view of the principal part. In the pixel unit 10, a plurality of anodes 22 which is the stripe-shaped (belt-shaped) transparent electrode is provided on the transparent film-shaped plastic 21, and a sheet-shaped organic EL layer 28 constituted by a hole transport layer 23, a light emitting layer 24, and an electron transport layer 25 laminated thereon is provided on the anodes 22. A plurality of stripe-shaped cathodes 26 are provided orthogonal to the anodes 22, and a protective layer 27 is provided thereon. The organic EL elements 20 are formed at positions at which the anodes 22 which is the transparent electrode and the cathodes 26 cross each other. Here, the pixel unit 10 is housed by rolling in an X direction orthogonal to the anodes 22. As a result, a configuration can be provided in which the bending stress is not applied to the anodes 22 in housing by rolling.

A film-shaped plastic substrate 21 serves as a support of the organic EL element 20, and layers constituting the organic EL element 20 are formed on the film-shaped plastic substrate 21. It is also preferable that a plastic film is provided on a surface opposite to the film-shaped plastic substrate 21 of the organic EL element 20 so as to further protect the organic EL element.

As long as a material used for the film-shaped plastic substrate 21 has a high transparency, the material used for the film-shaped plastic substrate 21 is not particularly limited. It is preferable to use plastic films such as polyester such as polyethylene terephthalate, polybutylenephthalate, and polyethylenenaphthalate, polystyrene, polycarbonate, polyethersulfone, polyarylate, polyimide, polycycloolefin, norbornene resin, and poly(chlorotrifluoroethylene) as the material used for the film-shaped plastic substrate 21. It is preferable that a gas barrier layer for preventing transmission of moisture or oxygen, a hard coat layer for preventing damage to the organic EL element 20, and an undercoat layer for improving flatness of the film-shaped plastic substrate 21 or adhesiveness with the anodes 22 are provided on the film-shaped plastic substrate 21.

Here, a thickness of the film-shaped plastic substrate 21 is preferably in the range of 50 μm to 500 μm. The reason for this is as follows. When the thickness of the film-shaped plastic substrate 21 is smaller than 50 μm, the film-shaped plastic substrate 21 has difficulty in maintaining a sufficient flatness. Accordingly, when the organic EL element 20 is configured, it may be difficult to maintain excellent flatness of the organic EL element 20. When the thickness of the film-shaped plastic substrate 21 is larger than 500 μm, it is difficult to flexibly bend the film-shaped plastic substrate 21, that is, flexibility of the film-shaped plastic substrate 21 becomes poor. Accordingly, when the organic EL element 20 is configured, the flexibility of the organic EL element 20 becomes worse.

The anode 22 may generally be any material as long as it has a function as an electrode for supplying positive holes to the organic EL layer 28, which is transparent to a light emitted in the organic EL layer, and there is no particular limitation. It may be suitably selected from among well-known electrode materials.

Specific examples of the anode materials include metal oxides such as tin oxides doped with antimony, fluorine or the like (ATO and FTO), tin oxide, zinc oxide, indium oxide, indium tin oxide (ITO), indium zinc oxide (IZO), and zinc oxide doped with aluminium or gallium (AZO and GZO). Among these, ITO is preferable as an anode material for an organic EL element in view of hole injection property, productivity, electro-conductivity, transparency and the like.

The thickness of the anode 22 is preferably from 100 nm to 500 nm. In a case where the thickness is less than 100 nm, the anode 22 ceases to function sufficiently as an anode since the is thickness is too thin, which is not preferred. In a case where the thickness exceeds 500 nm, a transparency of visible light is hindered, and the device ceases to be applicable to practical use. A value of resistance of the anode is preferably 10³ Ω/o or less, and 10² ≠/□ or less is more preferable. A transparency of the anode is preferably 60% or more, and 70% or more is more preferable.

A bending strength of the above-described metal oxides used as an anode material is poorer than that of materials used for the cathode 26 to be described below. The bending strength in the present invention means a strength at which fracturing occurs when bending stress is applied to an electrode. Metal oxides are generally brittle and poorer in bending strength than materials having a large malleability such as metals or metal alloys.

A positive hole-transport layer 23 is a layer that has a function of accepting positive holes from the anode 22 and transporting the holes to a light emitting layer 24. Specific examples of the positive hole transporting material that can be used in the present invention include a carbazole derivative, a triazole derivative, an oxazole derivative, an oxadiazole derivative, an imidazole derivative, a polyarylalkane derivative, a pyrazoline derivative, a pyrazolone derivative, a phenylenediamine derivative, an arylamine derivative, an amino-substituted chalcone derivative, a styrylanthracene derivative, a fluorenone derivative, a hydrazone derivative, a stilbene derivative, a silazane derivative, an aromatic tertiary amine compound, a styrylamine compound, an aromatic dimethylidene-based compound, a porphyrin-based compound, an organic silane derivative, carbon, and various metal complexes typically exemplified by an Ir complex having a ligand of phenyl azole or phenylazine. However, the positive hole transporting material in the present invention is not limited to these compounds.

The light-emitting layer 24 is a layer having a function for receiving positive holes from the positive hole transport layer 23, and receiving electrons from an electron transport layer 25, and for providing a field for recombination of the positive holes with the electrons to emit light. The light-emitting layer 24 of the present invention may contain only a light emitting material or may be configured as a combination layer of a light emitting material and a host material. Either of fluorescent emitting materials or phosphorescent emitting materials can be used, and also one dopant or a plurality of dopants can be used. The host material is preferably a charge transport material. The host material may be one compound or a combination of two compounds or more, and for example, a combination layer of an electron transporting host material and a hole transporting host material can be used.

Examples of the fluorescent emitting materials that can be used in the present invention include, for example, a benzoxazole derivative, a benzimidazole derivative, a benzothiazole derivative, a styrylbenzene derivative, a polyphenyl derivative, a diphenylbutadiene derivative, a tetraphenylbutadiene derivative, a naphthalimide derivative, a coumarin derivative, a condensed aromatic compound, a perinone derivative, an oxadiazole derivative, an oxadizine derivative, an aldazine derivative, a pyralidine derivative, a cyclopentadiene derivative, a bis-styrylanthracene derivative, a quinacridone derivative, a pyrrolopyridine derivative, a styrylamine derivative, a diketopyrrolopyrole derivative, aromatic dimethylidene compounds, a variety of metal complexes represented by metal complexes of 8-quinolynol or metal complexes of a pyromethene derivative, polymer compounds such as polythiophene, polyphenylene and polyphenylenevinylene, organic silanes, and the like. However, the fluorescent emitting material in the present invention is not limited to these compounds.

Examples of the phosphorescent emitting materials that can be used in the present invention include complexes containing transition metal atoms or lantanoid atoms. For instance, although the transition metal atoms are not limited, they are preferably ruthenium, rhodium, palladium, tungsten, rhenium, osmium, iridium, or platinum, and more preferably rhenium, iridium, or platinum. Preferable examples of the lantanoid atoms include lanthanum, cerium, praseodymium, neodymium, samarium, europium, gadolinium, terbium, dysprosium, holmium, erbium, thulium, ytterbium, and lutetium, and among these lantanoid atoms, neodymium, europium, and gadolinium are more preferred.

Specific examples of the ligand of the complex include preferably halogen ligands (preferably chlorine ligands), nitrogen-containing heterocyclic ligands (e.g., phenylpyridine, benzoquinoline, quinolinol, bipyridyl, or phenanthroline and the like), diketone ligands (e.g., acetylacetone and the like), carboxylic acid ligands (e.g., acetic acid ligands and the like), carbon monoxide ligands, isonitryl ligands, and cyano ligand, and more preferably nitrogen-containing heterocyclic ligands.

The phosphorescent emitting material is preferably contained in amount of 0.1 weight % to 40 weight %, and more preferably 0.5 weight % to 20 weight % in the light emitting layer 24.

The host material contained in the light emitting layer in the present invention is preferably a compound having a carbazole skeleton, a diarylamine skeleton, a pyridine skeleton, a pyrazine skeleton, a triazine skeleton or an aryl silane skeleton, or materials exemplified in the description of the hole transport layer 23 or the electron transport layer 25. However, the host material in the present invention is not limited to these compounds.

The electron transport layer 25 is a layer having a function for receiving electrons from the cathode 26, and transporting electrons to the light emitting layer 24. Specific examples of the materials applied for the electron transport layer 25 include a triazole derivative, an oxazole derivative, an oxadiazole derivative, an imidazole derivative, a fluorenone derivative, an anthraquinodimethane derivative, an anthrone derivative, a diphenylquinone derivative, a thiopyrandioxide derivative, a carbodiimide derivative, a fluorenylidenemethane derivative, a distyrylpyradine derivative, tetracarboxylic anhydrides of arycyclic compounds such as perylene, naphthalene and the like, phthalocyanine derivative, metal complexes typically exemplified by metal complexes of 8-quinolinol derivatives, metal phthalocyanine, and metal complexes containing benzoxazole or benzothiazole as the ligand, and an organic silane derivative, and the like. However, the material applied for the electron transport layer in the present invention is not limited to these compounds.

The cathode 26 may generally be any material as long as it has a function as an electrode for injecting electrons to the organic EL layer. There is no particular limitation, and the material may be suitably selected from among well-known electrode materials. Materials constituting the cathode may include, for example, metals and alloys, but metal is preferred. Specific examples thereof include materials having a low work function such as alkali metals (e.g., Li, Na, K, Cs or the like), alkaline earth metals (e.g., Mg, Ca or the like), gold, silver, lead, aluminum, sodium-potassium alloys, lithium-aluminum alloys, magnesium-silver alloys, rare earth metals such as indium and ytterbium, and the like. However, the material constituting the cathode in the present invention is not limited to these metal compounds.

A protective layer 27 may generally be any material as long as it has a function to prevent penetration of substances such as moisture and oxygen, which accelerate deterioration of the device, into the device.

Specific examples thereof include metals such as In, Sn, Pb, Au, Cu, Ag, Al, Ti, Ni and the like; metal oxides such as MgO, SiO, SiO₂, Al₂O₃, GeO, NiO, CaO, BaO, Fe₂O₃, Y₂O₃, TiO₂ and the like; metal nitrides such as SiNₓ, SiNₓO_{y} and the like; metal fluorides such as MgF₂, LiF, AlF₃, CaF₂ and the like; polyethylene; polypropylene; polymethyl methacrylate; polyimide; polyurea; polytetrafluoroethylene; polychlorotrifluoroethylene; polydichlorodifluoroethylene; a copolymer of chlorotrifluoroethylene and dichlorodifluoroethylene; copolymers obtained by copolymerizing a monomer mixture containing tetrafluoroethylene and at least one co-monomer; fluorine-containing copolymers each having a cyclic structure in the copolymerization main chain; water-absorbing materials each having a coefficient of water absorption of 1% or more; moisture permeation preventive substances each having a coefficient of water absorption of 0.1% or less; and the like, but are not limited to these materials.

In a pixel unit 10 constructed as described above, by applying selectively a direct current between the anode 22 and the cathode 26 of the organic EL element 20, holes injected from the anode 22 are transported through the hole transport layer to the light emitting layer 24, and electrons injected from the cathode 26 are transported through the electron transport layer to the light emitting layer 24. Therefore, the holes and the electrons recombine at the light emitting layer 24 to result in light emission having a predetermined wave length. A pixel unit for full color display having three color light emission of R, Q B or for multi-color display can be prepared by selecting materials for the light emitting layer 24.

In the wiring unit 16, the wirings 13 constituted by two kinds of wirings including the longitudinal wirings 11 drawn from the cathode 26 of the organic EL element 20 and the transverse wirings 12 drawn from the anode 22 are disposed.

The longitudinal wirings 11 are drawn from the cathode 26 and are disposed in a direction orthogonal to the circuit unit 3 on the display unit 2, that is, in a direction substantially orthogonal to the circuit unit 3 and the first side 14. As shown in FIG. 4, the longitudinal wirings 11 extend substantially linearly from the pixel unit 10 to the circuit unit 3 and connect the drive circuits 7 with the organic EL elements 20.

The transverse wirings 12 are drawn out from the anode 22 toward the circuit unit 3 at an angle of about 45° to a direction parallel to the circuit unit 3 on the display unit 2. Thereafter, the transverse wirings 12 extend substantially linearly to the circuit unit 3 and connect the drive circuits 7 with the organic EL elements 20.

In FIG. 4, the transverse wirings 12 are drawn in both directions of the pixel unit 10. The pixel unit 10 is disposed substantially in the center in a direction parallel to the first side 14 of the display unit 2, and the transverse wirings 12 are drawn in both directions of the pixel unit 10, whereby it is possible to dispose the pixel unit 10 substantially in the center in the direction parallel to the first side 14 of the display unit 2. it is not necessarily required that the transverse wirings 12 be drawn in both directions of the pixel unit 10, and the transverse wirings 12 may be drawn in any one direction of the pixel unit 10.

Materials of the longitudinal wirings 11 and the transverse wirings 12 include materials such as Au, Cr, Al, and Cu having low specific resistance and chemical stability.

In the display unit 2 having the above-mentioned configuration, the anodes 22 of the pixel unit 10 are disposed perpendicular to a rolling direction X. Accordingly, when the display unit 2 is housed by rolling, the bending stress is not applied to the anodes 22. As a result, since the anodes 22 are not broken in repeated housing by rolling, it becomes possible to perform stable display of the display unit over a long period of time.

In the above description, a case in which an angle between the rolling direction X and the anodes 22 is 90° is described, but the angle between the rolling direction X and the anodes 22 is not necessarily required to be 90° in the organic EL display device according to the embodiment of the invention.

For example, it is possible to achieve the effect of preventing the anodes 22 from being broken even if the angle is inclined somewhat from 90° due to a manufacturing error. When the pixels are arranged in a delta arrangement for the purpose of displaying a high-quality image, it is possible to incline the anodes in accordance with a pixel array without making the anodes and the cathodes orthogonal to each other in a passive matrix-type display element. At this time, angles between the anodes and the cathodes are in the range of 10° to 30°. From this viewpoint, a perpendicular direction according to the embodiment of the invention may be in the range of 90°±30°.

A substrate of the pixel unit 10, that is, a substrate of the organic EL element 20 constituting the pixel unit 10 also serves as a substrate of the display unit 2, and a transparent substrate having flexibility is used as the substrate. By using a substrate having flexibility as the substrate of the display unit 2, it becomes possible to impart flexibility to the display unit 2. By imparting flexibility to the display unit 2, it becomes possible to bend and roll the display unit 2, whereby it becomes possible to house the display unit 2 by rolling.

The circuit unit 3 is disposed at one end portion of the display unit 2, and the drive circuits 7 controlling driving of the organic EL element 20, a power supply circuit (not shown) supplying power to the entire organic EL display device 1, and a signal processing circuit (not shown) receiving a display signal are housed therein. The circuit unit 3 is configured by covering circuits with circuit housing units 3a and 3b. The circuit housing unit protects circuits and serves as a shaft at the time of housing the display unit 2 by rolling. It is preferable that the circuit housing unit has a cylindrical shape. By this configuration, it is possible to prevent a surface of the display unit 2 from being damaged or receiving uneven stress at the time of housing the display unit 2 by rolling. When it is considered that the circuit housing unit serves as the shaft at the time of housing the display unit 2 by rolling, it is preferable that a diameter or a thickness of the circuit housing unit is set to a predetermined size by taking the mechanical strength of the materials constituting the display unit 2 into consideration.

The housing unit 4 is a part for housing the display unit 2 by rolling. As shown in FIG. 1, a rectangular cylindrical-shaped screen housing unit body 4a is disposed so as to cover a circuit housing case substantially with the circuit housing case at the center thereof. Here, an opening portion 5 having a width slightly larger than a thickness of the display unit 2 along a length direction of the screen housing body 4a is provided in the screen housing body 4a. When the display unit 2 is housed or drawn out by providing the opening portion 5, the display unit 2 moves into and out of the opening portion 5.

In the invention, the screen housing unit 3a has a rectangular cylindrical shape in consideration of stability when the screen housing unit 3a is placed on a desk or the like, but the invention is not limited theseto. For example, when the organic EL display device is housed by rolling, the screen housing unit 3a may have a cylindrical shape resistant to scratches and external force.

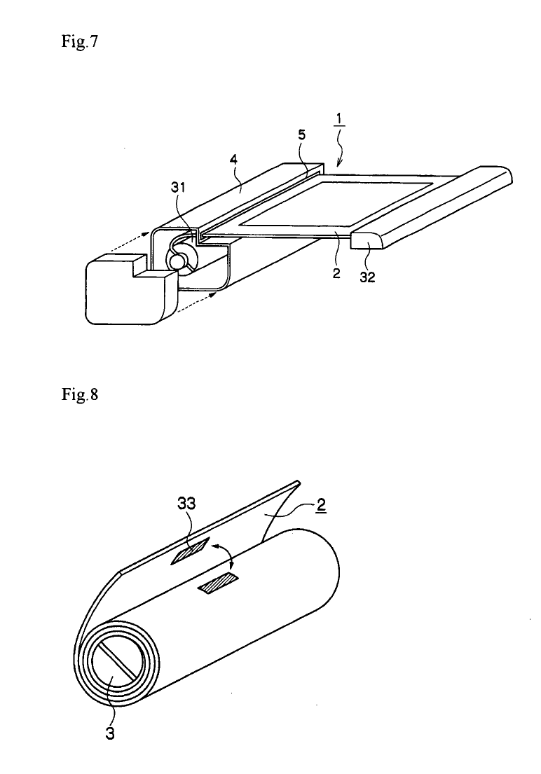

As shown in FIG. 7, it is preferable that a handle 32 having a width and a thickness slightly larger than the width of the opening portion 5 provided in the housing unit 4 is provided at one side opposite to a side at which a rolling unit 31 of the display unit 2 is provided. The handle 32 is provided at an end portion of the display unit 2, whereby it is possible to prevent the inconvenience of the display unit 2 entirely moving into the housing unit 4 so that the display unit 2 cannot be drawn out. By this configuration, circuits for driving the display unit 2 may be disposed in either the rolling unit 31 or the handle 32.

In the above description, a case in which the organic EL display device 1 has the housing unit 4 and the display unit 2 is housed in the housing unit 4 is described, but the organic EL display device according to the invention may not always have the housing unit.

For example, the display unit 2 may be housed by rolling with the circuit unit 3 as a shaft without providing the housing unit. In this case, it is preferable that a plastic film is disposed as a protective sheet on one principal surface of the display unit 2, that is, on a principal surface opposite to a principal surface on which an image is displayed in the display unit.

It is possible to prevent the display unit 2 from being damaged at the time of housing the display unit 2 by rolling by disposing the plastic film. It is possible to protect the organic EL display device from being exposed to external moisture at the time of housing the display unit 2 by rolling by using the plastic film having a gas barrier property.

It is preferable that means for maintaining the display unit 2 to be housed by rolling is provided when the housing unit is not provided. For example, the display unit 2 housed by rolling may be simply kept from unrolling by a band. Further, a predetermined position of the display unit located in an outermost periphery and a position corresponding thereto at the time of housing the display unit by rolling may be latched by a magnet 33 as shown in FIG. 8.

In the above description, a case in which the organic EL display device 1 has the housing unit 4 and the display unit 2 is housed in one housing unit 4 is described, but in the organic EL display device according to the invention, the display unit may not be housed in one housing unit, and instead the display unit may be housed in two housing units.

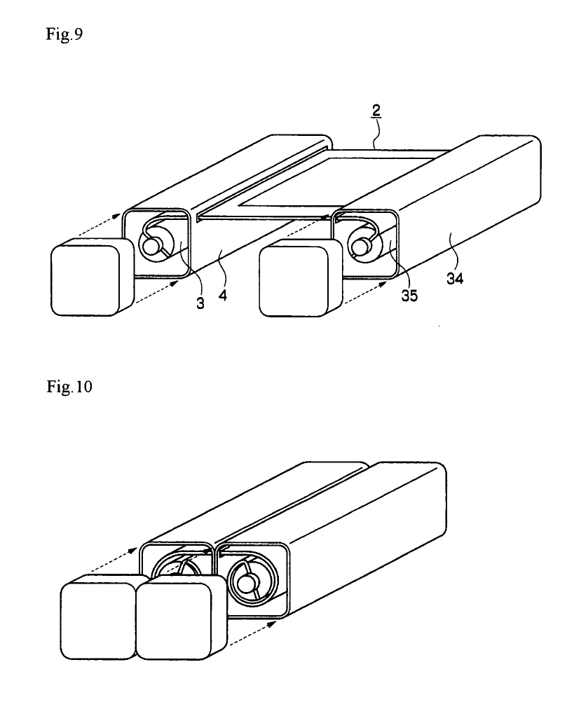

As shown in FIG. 9, the circuit unit 3 serving as a first rolling unit and a second rolling unit 35 are provided at both ends of the display unit 2 and can be rolled from the both ends of the display unit 2, respectively. The circuit unit 3 is housed in the first housing unit 4, and the second rolling unit 35 is housed in the second housing unit 34. FIG. 9 illustrates an operating state of displaying an image by drawing out the display unit 2 for using the organic EL display device, and FIG. 10 illustrates a state in which the organic EL display device is housed. The first housing unit 4 and the second housing unit 34 are pulled away from each other, whereby the display unit 2 is drawn out from the first housing unit 4 and the second housing unit 34 to be switched to the operating state from the housing state. The drive circuits for driving the display unit 2 may be entirely housed in the circuit unit 3, or a part of the drive circuits may be divisionally housed in the second rolling unit 35.

In the above description, a case in which the display unit 2 is drawn out from the housing unit 4 in a flat state is described in the organic EL display device 1, but in the organic EL display device according to the invention, the display unit 2 does not need to be drawn out from the housing unit 4 in a flat state.

As shown in FIG. 11, the display unit 2 is drawn out from or housed in an opening portion 37 provided in a housing unit 36. Here, the opening portion 37 has a circular arc shape, and the display unit 2 is drawn along the circle arc of the opening portion 37. Accordingly, the display unit 2 may hold a concave surface shape while the display unit 2 is drawn out. The display unit 2 may hold a convex surface shape while the display unit 2 is drawn by reversing the circular arc shape of the opening portion 37 in the up and down direction. It is preferable that the display unit 2 and the substrate of the display unit 2 are molded in accordance with the shape of the opening portion 37 for preventing the display unit 2 from being damaged due to sliding between the display unit 2 and the opening portion 37. By this configuration, it is possible to improve a recognition property of an image displayed on the display unit 2.

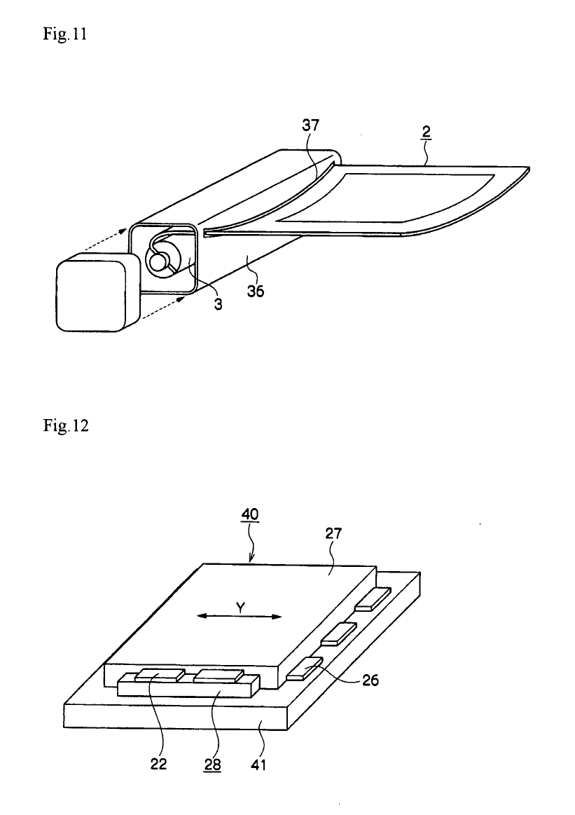

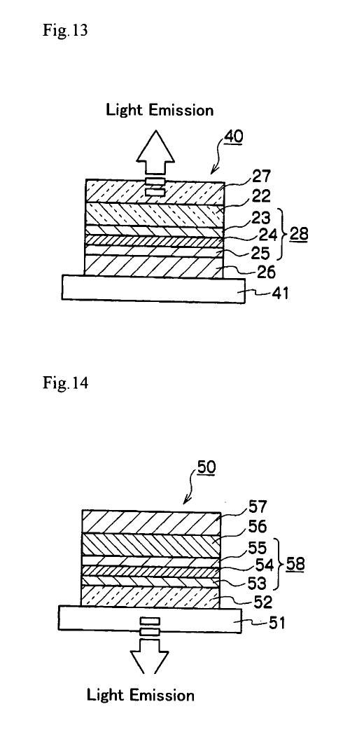

In the above-mentioned organic EL display device 1, light emission of the organic EL element 20 may be extracted from the protective layer 27. In this case, the configuration of the organic EL element is opposite to the configuration of the organic EL element 20 in which light emission is extracted from the film-shaped plastic substrate, and the organic EL element becomes an organic EL element 40 having configurations shown in FIGS. 12 and 13. That is, the organic EL element 40 includes a substrate 41, cathodes 26 formed on the substrate 41, an electron transport layer 25 formed on the cathodes 26, a light emitting layer 24 formed on the electron transport layer 25, a hole transport layer 23 formed on the light emitting layer 24, anodes 22 formed on the hole transport layer 23, and a protective layer 27 formed on the anodes 22.

In the display unit 2 having the organic EL element 40 having the above-mentioned configuration, the anodes 22 of the pixel unit 10 are disposed perpendicular to a rolling direction Y. Accordingly, when the display unit 2 is housed by rolling, the bending stress is not applied to the anodes 22. As a result, since the anodes 22 are not broken in repeated housing by rolling, it becomes possible to perform stable display of the display unit over a long period of time.

Here, the film-shaped plastic substrate may be used for the substrate 41, but since it is not necessarily for light emission to be extracted from the organic EL element 40, an opaque substrate such as a film-shaped metal substrate may be used for the substrate 41. It is preferable that the film-shaped metal substrate is used for the substrate 41 since the film-shaped metal substrate has a gas barrier property higher than the film-shaped plastic substrate. When a film-shaped metal is used as a substrate of the organic EL element 40, it is necessary that an insulating layer for additionally ensuring an electrical insulation property of the cathodes 26 is provided between the substrate 41 and the cathodes 26.

Materials used for the film-shaped metal substrate 41 include metals such as stainless steel, Fe, Al, Ni, Co, or Cu, or alloys thereof which can hold a film shape at a normal temperature and a normal pressure.

The organic EL display device 1 having the above-mentioned configuration can be manufactured as follows.

First of all, a film-shaped plastic substrate 71 is coated with an ITO layer made of a transparent conductive material serving as an anode, and patterning is performed on the film-shaped plastic substrate 71 coated with the ITO layer, whereby anodes 72 which are stripe-shaped transparent electrodes are formed as shown in FIG. 16.

Next, an insulating material is applied onto the stripe-shaped anodes 72 formed as above, which are coated with the insulating layer, and patterning is additionally performed on the stripe-shaped anodes 72 coated with the insulating layer, whereby an insulating layer 74 having an opening portion 73 is formed on the anodes 72 as shown in FIG. 17.

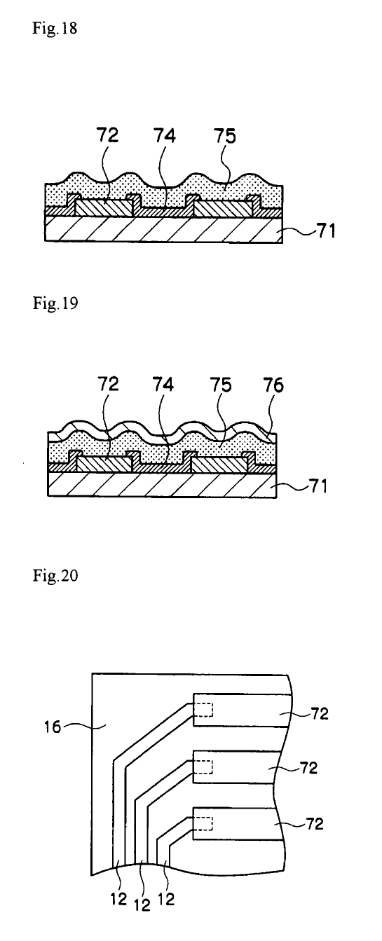

Next, an entire surface of the anodes 72 is coated with an organic material for an organic EL layer by a vacuum deposition method, and the insulating layer 74 is covered with the organic material for an organic EL layer as shown in FIG. 18, whereby an organic EL layer 75 abutting a top surface of the anodes 72 is formed in the above-mentioned opening portion 73. Here, the organic EL layer 75 is formed by performing coating of the hole transport layer, the light emitting layer, and the electron transport layer sequentially by the vacuum deposition method.

Thereafter, patterning is performed on the organic EL layer 75 with a mask, and the stripe-shaped cathodes 76 orthogonal to the anodes are formed as shown in FIG. 19, whereby it is possible to obtain the pixel unit employing the organic EL element.

Next, connections between the organic EL elements and the circuits will be described. Here, the wirings 13, that is, including the longitudinal wirings 11 and the transverse wirings 12 are formed in advance in the wiring unit 16 shown in FIG. 4 by patterning with the mask, whereby the anodes 72 and the transverse wirings 12 are electrically connected to each other as shown in FIG. 20.

In the above description, the cathodes 76 are formed after the insulating layer 74 and the organic EL layer 75 are formed, but the cathodes 76 are formed in an area slightly larger than the pixel unit 10 by patterning with the mask so that the cathodes 76 are overlapped with the longitudinal wirings 11. By this configuration, the longitudinal wirings 11 formed in advance and the cathodes 76 are electrically connected to each other. Accordingly, the longitudinal wirings 11 are drawn from the cathodes 76 and the transverse wirings 12 are drawn from the anodes 72.

Next, a protective layer is formed by a CVD method so as to cover the organic layer 75.

Next, the longitudinal wirings 11 and the transverse wirings 12 formed as above are connected to drive circuits 5, whereby it is possible to connect the organic EL elements with the circuits.

Next, circuits such as the drive circuits are sealed by the circuit housing units 3a and 3b.

Finally, the sealed circuit unit 3 is attached to the housing unit 4 so that a bearing part provided in the housing unit engages with the rotation shaft 6 provided in the circuit unit, whereby it is possible to obtain the organic EL display device shown in FIG. 1.

In the above description, the pixel unit 10 is formed of the organic EL display device constituted by the organic EL element 20, but the EL display device according to the invention is not limited thereto, and the pixel unit 10 may be formed of an inorganic EL display device constituted by an inorganic EL element.

In the inorganic EL display device, the pixel unit may be formed of a plurality of inorganic EL elements arranged in a matrix. FIG. 14 illustrates a longitudinal sectional view of a principal part illustrating a configuration of an inorganic EL element 50. In other words, in the pixel unit of the inorganic EL display device, a plurality of first electrodes 52 which is the stripe-shaped transparent electrode is provided on a transparent film-shaped plastic substrate 51. A sheet-shaped inorganic EL layer 58 constituted by a first dielectric layer 53, a light emitting layer 54, and a second dielectric layer 55 laminated on the first electrodes 52 is provided on the first electrodes 52. A plurality of stripe-shaped second electrodes 56 serving as a reflective electrode is provided orthogonal to the first electrode 52. A protective layer 57 is provided on the second electrodes 56. The inorganic EL element 50 is formed at a position at which the first electrodes 52 and the second electrodes 56 which are the transparent electrodes cross each other.

Here, it is preferable to use materials in which a transition metal element such as Mn or Cu or a rare-earth element such as Eu, Ce, Tb, Er, Tm, or Sm is added as a dopant to a sulfide base material such as ZnS, CaS, SrS, or BaAl₂S₄ as the material used for the light emitting layer 54. It is preferable to use a material having a high dielectric constant such as Y₂O₃, Ta₂O₅, TiO₂, BaTiO₃, or SrTiO₃ as the material used for the first dielectric layer 53 and the second dielectric layer 55. It is preferable to use a material having a high transparency such as ITO, IZO, AZO, or GZO as the material used for the first electrode 52. It is preferable to use a metal having a high reflectance such as Al, Cr, Au, or Ag, and alloys thereof as the material used for the second electrode 56.

In the above description, the film-shaped plastic substrate 51 is used, but an opaque substrate such as the film-shaped metal substrate may be used. The film-shaped metal substrate is preferable for forming the light emitting layer 54 and the dielectric layer requiring a substrate temperature at the time of coating since the film-shaped metal substrate has a heat resistance higher than the film-shaped plastic substrate. When the film-shaped metal is used as the substrate of the inorganic EL element 50, it is necessary to provide a configuration in which emission from the inorganic EL layer 58 is extracted from the protective layer 57 by reversing the positions the first electrodes 52 and the second electrodes 56 and to additionally provide an insulating layer for ensuring an electrical insulation property of the second electrodes 56 between the substrate 51 and the second electrodes 56.

In the display unit 2 having the inorganic EL element 50 having the above-mentioned configuration, the first electrodes 22 of the pixel unit 10 are disposed perpendicular to the rolling direction similarly to the organic EL element. Accordingly, when the display unit 2 is housed by rolling, the bending stress is not applied to the first electrodes 52. As a result, since the first electrodes 52 are not broken in repeated housing by rolling, it becomes possible to perform stable display of the display unit over a long period of time.

In the above description, the pixel unit 10 is formed of the organic EL display device constituted by the organic EL element 20, but the display device according to the invention is not limited thereto, and the pixel unit 10 may be formed of an electrophoresis display device constituted by an electrophoresis element.

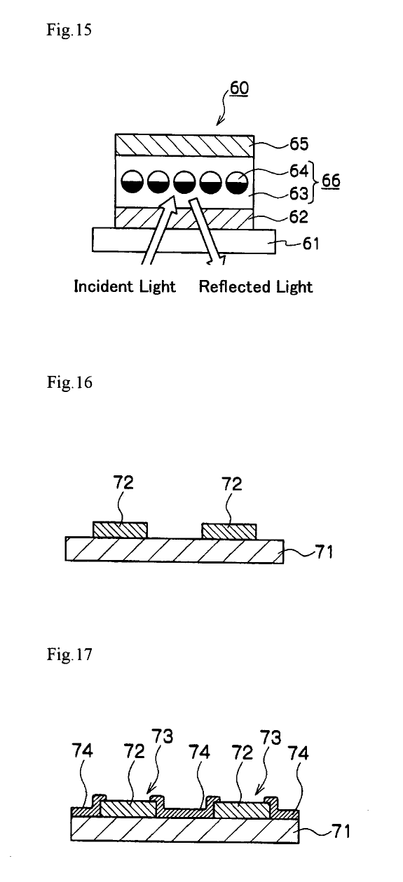

In the electrophoresis display device, the pixel unit may be formed of a plurality of electrophoresis elements arranged in a matrix. FIG. 15 is a longitudinal sectional view of a principal part illustrating a configuration of an electrophoresis element 60. In other words, in the pixel unit of the electrophoresis display device, a plurality of first electrodes 62 which is the stripe-shaped transparent electrode is provided on the transparent film-shaped plastic substrate 61. A display layer 66 constituted by a dielectric layer 63 and microcapsules 64 distributed in the dielectric layer 63 and having pigment charged with different charges of two-colors is provided on the first electrodes 62. A plurality of stripe-shaped second electrodes 65 serving as a reflective electrode is provided orthogonal to the first electrodes 62. The electrophoresis element 60 is formed at a position at which the first electrodes 62 which is the transparent electrode and the second electrodes 65 cross each other.

In the display unit 2 having the electrophoresis element having the above-mentioned configuration, the first electrodes 52 of the pixel unit 10 are disposed perpendicular to the rolling direction similarly to the organic EL element. Accordingly, when the display unit 2 is housed by rolling, the bending stress is not applied to the first electrodes 62. As a result, since the first electrodes 62 are not broken in repeated housing by rolling, it becomes possible to perform stable display of the display unit over a long period of time.

In the above description, a passive matrix-type flexible display device in which the pixel unit is constituted by the EL element or the electrophoresis element is described, but the invention is not limited thereto, and the invention can be applied to a flexible display device constituted by signal wirings or a display element using metal oxide as a material for one stripe-shaped display electrode of the display element.

### DESCRIPTION IN DRAWINGS

1: organic EL display device, 2: display unit, 3: circuit unit; 3a: circuit housing unit body; 3b: circuit housing unit cap, 4: housing unit; 4a; housing unit body; 4b: housing unit cap, 5: opening portion, 6: rotation shaft, 7: drive circuit, 10: pixel unit, 13: wiring; 11: longitudinal wiring; 12: transverse wiring, 16: wiring unit, 20: organic EL element, 21: film-shaped plastic substrate, 22: anode, 26: cathode, 27: protective layer, 28: organic EL layers; 23: hole transport layer; 24: organic light emitting layer, 25: electron transport layer, 32: handle, 33: magnet, 34: second housing unit, 35: second rolling unit, 36: housing unit, 37: circular arc-shaped opening, 40: top emission type organic EL element, 41: film-shaped metal substrate, 50: inorganic EL element, 51: film-shaped plastic substrate, 52: first electrode, 58: inorganic EL layers; 53; first dielectric layer; 54: inorganic light emitting layer; 55: second dielectric layer, 56: second electrode, 57: protective layer, 60: electrophoresis element, 61: film-shaped plastic substrate, 62: the first electrode, 65: the second electrode, 66: display layer, 63: dielectric layer, 64: microcapsule, 71: film-shaped plastic substrate, 72: anode, 73: annode opening part, 74: electric insulating layer, 75: organic EL layer, 76: cathode.

What is claimed is:

1. A display device comprising a display unit and a circuit unit for driving the display unit, in which the display unit includes a flexible substrate, a pair of electrodes disposed on the flexible substrate, and at least one display element between the electrodes, wherein the display unit is housed by rolling and drawn out in a predetermined direction, one of the electrode is a metal electrode, the other electrode is a stripe-shaped electrode comprising a metal oxide, and a long side of the stripe is disposed perpendicular to a rolling direction of the display device.

2. The display device according to claim 1, further comprising a housing unit for housing the display unit and the circuit unit.

3. The display device according to claim 2, wherein the housing unit comprises an opening portion for moving the display unit into and out of the housing unit, and the opening portion has a circular arc shape so as to hold a curve of the display unit.

4. The display device according to claim 2, wherein the housing unit further comprises a rolling unit for rolling the display unit.

5. The display device according to claim 4, wherein the circuit unit is disposed within the rolling unit.

6. The display device according to claim 1, wherein the display element emits light or undergoes change in an optical property by an applied electric field.

7. The display device according to claim 1, wherein the display element is a light emitting element.

8. The display device according to claim 7, wherein the light emitting element is an organic EL element.
